(19) United States
(12) Patent Application Publication
(10) Pub. No.: US 2010/0252536 A1
(43) Pub. Date: Oct. 7, 2010

(54) Contact tip for an electrode of a resistance welder

(75) Inventors: Keith A. Spencer, Danville, KY (US); Clay Donaldson, Lancaster, KY (US); Thomas M. Fogh, Stanford, KY (US)

Correspondence Address: KENNETH F. PEARCE, 631 DENMARK DRIVE, DANVILLE, KY, 40422-2419, US

(73) Assignee: Ascend Enterprises, Inc.

(21) Appl. No.: 12/798,096

(22) Filed: Mar. 30, 2010

Related U.S. Application Data
(63) Continuation-in-part of application No. 12/384,489, filed on Apr. 6, 2009.

(51) Int. Cl. B23K 11/30

(52) U.S. Cl. 219/119

(57) ABSTRACT

A contact tip used with the electrode of a resistance welder. The contact tip includes a bore that has an insert of blended tungsten and copper inserted therein. Prior to insertion of the insert into the bore, the bore is lined with a composition containing silver. A brazing process can be utilized to enhance attachment of the insert to the contact tip.

This application is a Continuation-in-Part of pending Application for Letters patent Ser. No. 12/384,489 entitled—Contact Tip for an Electrode of a Resistance Welder—filed on Apr. 6, 2009.

### BACKGROUND OF THE INVENTION

1. Field of the Invention

In the most general sense, the present invention relates to contact tips for resistance welders. The contact tip has a body that is provided with a recess at a first end and a bore at a second end. Bodies are made of at least 99.0% w/w copper. An insert of tungsten, tellurium and copper or tungsten, chromium, zirconium, silver tungsten, tellurium and copper is inserted into the body's bore. In preferred embodiments, the insert has a convex end and extends more than 3.175 mm beyond the outer periphery of the body. A layer of a composition containing silver is brazed to the bore prior to insertion of the insert.

2. Description of the Previous Art

Any discussion of references cited in this Description of the Previous Art merely summarizes the disclosures of the cited references and Applicant makes no admission that any cited reference or portion thereof is relevant prior art. Applicants reserve the right to challenge the accuracy, relevancy and veracity of the cited references.

1) US Published Patent Application 20050155960—Bonnet discloses a laser/arc hybrid welding process for ferritic steels. Bonnet, Paragraphs 122 and 123, reads, “It should be noted that, in TIG and plasma welding, it is not possible to use oxidizing shielding gases as otherwise the tungsten electrode would be destroyed. However, if the hybrid welding equipment allows there to be two separate gas feeds, one of laser beam assistance gas and the other for the plasma or TIG arc, the laser assistance gas may be different and therefore contain oxygen since, in such a case, this oxidizing gas is not in direct contact with the tungsten electrode.

Among other things, Bonnet does not teach or suggest the use of a contact tip with a body composed of copper, chromium, zinc and lead or a body composed of copper, cobalt, nickel and zirconium, where the contact tip has a cylindrical bore that is lined with a silver composition or an insert containing tellurium for insertion into the bore.

2) U.S. Pat. No. 5,126,528—Bush, et al. enables a resistance welding electrode having an angled nose and process of fabrication thereof. Column 9, lines 33-41, reads, “The metallurgy used for electrode body 125 or electrode body 225 or electrode body 725 or the other electrodes in FIGS. 8A-13A may vary, but preferably is a conventional copper alloy. For example, such copper alloy may be copper alloyed or otherwise combined with one or more metals selected from the group consisting of chromium, zirconium, cadmium, cobalt, nickel, beryllium, tungsten, aluminum, tungsten carbide, iron, and molybdenum.”

Among other things, Bush does not teach or suggest the use of a contact tip that has a cylindrical bore that is lined with a silver composition or an insert containing tellurium for insertion into the bore.

3) U.S. Pat. No. 5,015,816—Bush, et al. enables a resistance welding electrode and process. Column 8, lines 25-32, reads, “The metallurgy used for electrode body 125 or electrode body 225 or electrode body 725 may vary, but preferably is a conventional copper alloy. For example, such copper alloy may be copper alloyed or otherwise combined with one or more metals selected from the group consisting of chromium, zirconium, cadmium, cobalt, nickel, beryllium, tungsten, aluminum, tungsten carbide, iron, and molybdenum.”

Among other things, Bush does not teach or suggest the use of a contact tip that has a cylindrical bore that is lined with a silver composition or an insert containing tellurium for insertion into the bore.

4) U.S. Pat. No. 2,051,284—Ball enables an weld tip. Page 2, Column 2, lines 9-12, reads, “Moreover, only the tip need be formed of pure copper, copper alloy or relatively expensive metal, whereas the body may be formed of cheaper material, if desired.”

Among other things, Smith does not teach or suggest the use of a contact tip with a body composed of copper, chromium, zinc and lead or a body composed of copper, cobalt, nickel and zirconium, where the contact tip has a cylindrical bore lined with a silver composition or an insert containing tellurium for insertion into the bore.

5) U.S. Pat. No. 3,639,161—Trattner, et al. enables melt-resistant weld electrodes. Column 3, lines 1-9, reads, “The electrodes (composed of high-melting metallic materials, having melting characteristics of a melt-resistant or nonconsumable welding electrode such as tungsten, or a doped tungsten welding electrode wherein the doping material is selected from thorium, thorium dioxide, zirconium, zirconium dioxide, rhenium, rhenium dioxide and other similarly high-melting metals and metal oxides) are coated, at least on their tips, with a stable layer of high-melting metal-non-metal compound such as metal oxides, carbides, nitrides, or mixture thereof.”

Among other things, Trattner does not teach or suggest the use of a contact tip with body composed of copper, chromium, zinc and lead or a body composed of copper, cobalt, nickel and zirconium, where the contact tip has a cylindrical bore that is lined with a silver composition or an insert containing tellurium for insertion into the bore.

6) U.S. Pat. No. 4,588,870—Nadkarni, et. al. enables an resistance welding cap. Column 1, lines 55-64, reads, “The manufacture of automobiles is the largest application of resistance welding today. Until fairly recently virtually all the caps generally used in such service were of high strength, high conductivity copper alloys such as copper alloyed with a little chromium, zirconium, cadmium, cobalt, nickel, beryllium, tungsten, molybdenum, or a combination of these alloying agents. Representative alloys of this sort can contain about 0.1% to about 0.2% zirconium and about 0.6% to about 1% chromium. (For brevity, such metals and alloys may be referred to from time to time in this specification simply as “copper alloys”, because a copper-base alloy has been for so long the mainstay cap material for resistance welding operations in automobile production).”

Among other things, Nadkarni does not teach or suggest the use of a contact tip that has a cylindrical bore that is lined with a silver composition or an insert containing tellurium for insertion into the bore.

7) U.S. Pat. No. 5,714,735—Offer enables a method and apparatus for joining components with multiple filler materials. FIG. 2 teaches tungsten electrode (8). Column 10, line 68-Column 11, line 3, read, “Electrode holder 30 is preferably made of a conductive, oxidation-resistant material such as copper alloy (e.g., beryllium-copper alloy), optionally

Based on the current record, among other things, Offer does not teach or suggest use of a contact tip with a body composed of copper, chromium, zinc and lead or a body composed of copper, cobalt, nickel and zirconium, where the contact tip has a cylindrical bore that is lined with a silver composition or an insert containing tellurium for insertion into the bore.

8) U.S. Pat. No. 6,225,591—Nippert, et al. enables a resistance welding electrode and process for the electrode. Column 4, lines 23-25, read, “Preferably, the insert is formed from an internally oxidized copper-aluminum alloy or dispersion strengthened copper. The main body may be formed from a high conductivity copper or a silver bearing copper.”

Based on the current record, among other things, Nippert does not teach or suggest use of a contact tip with a body composed of copper, chromium, zinc and lead or a body composed of copper, cobalt, nickel and zirconium, where the contact tip has a cylindrical bore that is lined with a silver composition or an insert containing tellurium for insertion into the bore.

9) US Published Patent Application 20060261046—Scotchmer discloses a welding electrode and method. Paragraph 41 reads, “Referring to FIG. 3, tip region 60 may have a coating 70 formed thereon, as discussed below. It may be that body 30, may be made from a substantially pure copper, or a copper based alloy, having relatively high thermal conductivity (perhaps greater than 200 W/m K). Some alloys may be predominantly ternary alloys composed of Copper, Chromium and Zirconium (CuCrZr). Other alloys may be predominantly binary alloys, such as Copper and Zirconium (CuZr) or Copper and Chromium (CuCr). Copper Tungsten (CuW) and Copper Alumina (Cu—Al₂O₃) alloys may also possible alternate coating materials. One copper alloy with silver is suggested in U.S. Pat. No. 4,734,254 of Nippert, issued Mar. 29, 1988. Another alloy may be a dispersion strengthened alloy, as discussed in U.S. Pat. No. 4,423,617 of Nippert, issued Jan. 3, 1984. The dispersion strengthened alloy may be included in a portion of electrode 20 such as, for example only that portion forming the tip thereof.”

Based on the current record, among other things, Scotchmer does not teach or suggest use of a contact tip with a body composed of copper, chromium, zinc and lead or a body composed of copper, cobalt, nickel and zirconium, where the contact tip has a cylindrical bore that is lined with a silver composition or an insert containing tellurium for insertion into the bore.

10) US Published Patent Application 20060151453—Gordon discloses a consumable electrode arc welding. Paragraph 21 reads, “According to the present invention, there is provided a contact tip suitable for electric arc welding using a consumable electrode, wherein the contact tip has a body which defines a bore through which the electrode is able to pass, to enable electric current from a welding power supply to be transferred from the body to the electrode. Within a part of the length of the bore between an inlet end and an outlet end thereof, there is at least one region (hereinafter referred to as the primary contact region) at which the body is adapted to enable primary electrical contact with the electrode. Along the remainder part of the length of the bore, the body is adapted such that, in the event of any secondary contact between the body and the electrode along the remainder of the bore, the secondary contact does not substantially short circuit the primary electrical contact in the primary contact region of the bore.”

Paragraphs 138 and 139 read, “A practical alternative to increasing excessively the contact entry length is to use a different combination of materials at the entrance of the tip. FIG. 9 shows one example successfully trialled for use at high wire feed speeds and a wire consumable of diameter 1.2 mm. In FIG. 9 there is shown a contact tip 50 e in which components corresponding to those of tip 50 of FIG. 4 have the same reference numeral plus “e”. The tip 50 e has a body which defines sections 54 e and 60 e and which is mostly of copper. However, section 54 e includes an insert 74 within the copper body. The insert 74 is of annular form and of sintered tungsten. The insert 74 defines the taper 59 e and defines a 3 mm long inlet part of bore length 61 e of bore 52 e. The outside diameter of the tungsten insert 74 is approximately 0.05 mm larger than the recess in the copper part of section 54 e and the insert 74 is pressed into the copper body during assembly of the tip. The tungsten insert provides the first of two current delivery components with tungsten being chosen for its resistance to sliding wear by the wire consumable. Immediately following the tungsten insert 74, there is an 8 mm part bore length 61 e defined by copper. Relative to tungsten, the copper has low resistance to sliding wear and, in this arrangement, the copper has in effect replaced the graphite insert shown in tips of the type shown in FIG. 6. The section 64 e of the tip is an 18 mm long insert of machineable ceramic. For wire of diameter 1.2 mm the diameter of the part of bore length 61 e in the tungsten insert 74 is approximately 1.3 mm, the diameter of the part of the bore length 61 e of copper is approximately 1.25 mm and the diameter of the bore length 62 e in the ceramic insert is of section 64 e approximately 2.0 mm. As wire enters the tip it slides over the tungsten insert 74 and beds itself into the copper and is subsequently guided out of the tip through the ceramic section 64 e. The step change in diameter of the conducting part of the bore is small but significant. The step is large enough to establish a well defined contact area in the copper at or beyond the step. The precise location depends on the clearance between wire and bore, the wire stiffness and curvature. The back-up current delivery area is the tungsten insert in the region adjacent to the step. Both current delivery areas operate at essentially the same potential and an open circuit condition is unlikely. The preheat length is well defined and the wire melting rate uniform. Any obstruction to the smooth passage of wire is small and high wire feed speeds are therefore attainable. The lifetime of this type of tip is controlled by the wear rate of the tungsten. For non-pulsed GMAW and a wire feed speed of approximately 15 m/minute, the current required to maintain that melting rate is approximately 290 A for an applied voltage of 34V. For a conventional copper tip at the same wire feed speed the current required is approximately 400 A. The lifetime of the tip even at this high wire feed speed is approximately 2 hours. Tungsten is difficult to machine and is relatively expensive, and insert 74 therefore would preferably be sintered to as close to its final dimensions as possible. Other viable alternatives are hardenable carbon steels, silver steel, white irons and nickel and cobalt based hardfacing alloys. One tool steel, namely silver steel, has been found to be both effective and convenient to use. This is silver steel which is a 1% carbon tool steel supplied centreless ground to close tolerances. It is machineable and may be substantially hardened by heat treatment after machining. It has been successfully used as an alternative to tungsten both in its original as supplied condition and in its heat treated condition. One other option to a tungsten copper combination as described in FIG. 9 is to have an insert of silver steel in a body of mild steel. This would provide a good match between the coefficients of thermal expansion between the body and the insert.”

Gordon teaches a cylindrical bore extending through the weld tip. Gordon does not teach or suggest use of a contact tip with a body composed of copper, chromium, zinc and lead or a body composed of copper, cobalt, nickel and zirconium, where the contact tip has a cylindrical bore is lined with a silver composition or an insert containing tellurium for insertion into the bore.

11) U.S. Pat. No. 3,592,994—Ford enables a spot welding apparatus. Column 3, in part, reads, “The body 1 of the electrode, see FIG. 1, is formed, of a copper-chromium alloy known as “Mallory 3” (“Mallory” is a Registered Trade Mark) and the working end of the electrode has a force-fitted, hollow cylindrical reinforcing insert 2, the end face 3 of which constitutes an annular, peripheral zone of the contact face 4 of the electrode. The insert 2 is formed of a material known as “Elkonite 30W3” (“Elkonite” is a Registered Trade Mark), and comprises a sintered mass of tungsten particles with the interstices between them filled with copper. The electrode includes a cooling cavity 1A.”

Column, in part, 4 reads, “Although the embodiment described above refers to the use of “Mallory 3” alloy with a hollow cylindrical insert of “Elkonite 30W3”, the electrode may, for example, be made of any of the metals or alloys which are used for the manufacture of spot-welding electrodes and the insert may be of any metallic material which is stronger at elevated temperatures than the material of the electrode into which it is fitted. Of the materials which may be used for the insert, tungsten or molybdenum or alloys consisting principally of either or both of these metals, or materials consisting principally of a sintered aggregate of tungsten or molybdenum particles or both, are particularly suitable.”

And Column, in part, 5 reads, “The layer of silver or silver-based alloy may be introduced in the form of a washer placed at the root of the recess. In this way, application of pressure to the insert during force-fitting, back extrusion or swagging will not only cause deformation of the washer material to form good contact between the insert and root of the recess but also a certain amount of back extrusion of the washer material will take place between the inner and outer peripheries of the insert and the walls of the recess.”

Among other things, Ford does not teach or suggest the use of a contact tip that has an insert extending beyond the contact tip, brazing a silver composition onto a bore, elemental concentrations of elements in the silver composition, an electrode body containing zinc, lead or nickel or an insert containing tellurium for insertion into the bore.

12) U.S. Pat. No. 3,665,145—Engel enables a resistance welding electrode. Column 2, in part, reads, “Referring now to FIG. 2, there is illustrated an electrode 16 which can be utilized in accordance with the improvement of the present invention. The electrode 16 comprises a body 40 of copper of about ⅝ inch diameter and of conventional construction, including a passageway 42 into the body through which a cooling medium such as water may circulate, as indicated above. In accordance with the present invention, the outer tip portion surface 44 of the electrode 16 has plated thereon a material 46 having certain characteristics as will be defined hereinafter. The material 46 is plated to a thickness of from about 0.0001 to about 0.01 inches and defines the contact surface of the electrode 16. The plated material 46 can extend along the sides of the electrode 16 as indicated at 48, as a result of the plating method utilized, but is important only that the contact surface be defined by the material 46.”

Among other things, Engel does not teach or suggest the use of a contact tip that has an insert, a silver composition onto a bore or an electrode body containing elements other than copper.

13) U.S. Pat. No. 3,909,581—Stone, et al. enables a disposable resistance welding electrode. Columns 2 and 3, in part, read, “The holder member 10 may be made of any material having good electrical and thermal conductivity. It should be pointed out that the reason for utilizing a holder material which is different from the insert tip member 20 is one of cost. Therefore, the least expensive materials having sufficient electrical and thermal conductivity to conduct the current and remove heat from the electrode tips should be utilized. Additionally, some strength is required in this member because generally a pressure upwards of 600 pounds is utilized when the two electrode members are in contact with the work piece. Examples include aluminum and aluminum alloys, zinc and zinc base alloys preferably having at least 94% zinc by weight, iron and lower carbon iron. Particularly preferred are the 5,000 and 6,000 series of aluminum alloys and iron-carbon alloys having a carbon content below about 0.05 preferably below 0.02. Aluminum alloys which have been found to be particularly satisfactory alloys are EC, No. 2EC, 5005, 6061 and 6063 (Aluminum Association Designation). An exemplary zinc alloy is 4%-0.04% Mg, optionally 1% Cu, —a die casting alloy.

Inserted within holder member 10 is a tip insert 20. Tip insert member 20 should be made of a material which has high electrical and thermal conductivity. Not only must tip insert member 20 have high electrical and thermal conductivity as was the case with holder member 10, but also relatively high strength at the operating temperature is necessary because a smaller cross-sectional area bears the force of upwards of 600 pounds utilized during operation for welding. Particularly satisfactory materials are copper and copper alloys. Exemplary alloying elements include chromium, zirconium, beryllium, cadmium and combinations of the foregoing up to about 3% total addition by weight. Particularly satisfactory alloys are copper alloys containing about 0.2 to 1.5% total of chromium and/or zirconium. Cadmium alloys may be used with chromium and/or zirconium in an amount up to about 0.5% by weight. Additionally, refractory metals such as tungston or molybdenum or alloys thereof, or tungsten or molybdenum infiltrated with copper or silver may be utilized in some applications. it should be pointed out that alloys of silver, gold or platinum could be utilized for tip insert 20; however, it is believed that under most economic conditions the cost of these metals would dictate strongly against their use.”

Among other things, Stone does not teach or suggest the use of a contact tip that has a generally cylindrical insert with a convex tip, a silver composition brazed onto a bore, elemental concentrations of elements in the silver composition, an electrode body containing copper or elemental concentrations of tungsten and copper in the insert or an insert containing tellurium for insertion into the bore. Further, due to cost, Stone teaches against the use of silver for the insert.

14) U.S. Pat. No. 4,345,136—Nippert enables a copper bimetal brazed resistance welding electrode. Column 3, in part, reads, “The bi-metal resistance welding electrode of the present invention is illustrated in FIG. 1. This electrode includes a dispersion strengthened copper tip portion 15 which is formed of a copper-aluminum alloy which has been internally oxidized and cold worked. The electrode further includes a full-hard, hollow extruded shank portion 17 of high conductivity copper. The term high conductivity copper, as used herein, encompasses any of a number of copper compositions, such as pure copper and chromium-copper alloys, which are relatively inexpensive and provide sufficient strength when adequately cooled for the shank portion of a welding electrode. A brazed connection 19 between the shank portion 17 and the upper surface of the tip portion 15 joins these portions together. As described in greater detail below, the tip portion 15 has a coating of high conductivity copper (not shown in FIG. 1) adjacent the brazed connection 19.”

Among other things, Nippert does not teach or suggest the use of a contact tip that has a generally cylindrical insert, a silver composition brazed onto a bore, elemental concentrations of elements in the silver composition, the use of any tungsten, lead, zinc, cobalt, nickel or zirconium or an insert containing tellurium for insertion into the bore.

15) U.S. Pat. No. 4,954,687-Bush, et al. enables a resistance electrode and welding process. Column 7, in part, reads, “The metallurgy used for either electrode body 125 or electrode body 225 may vary, but preferably is a conventional copper alloy. For example, such copper alloy may be copper alloyed or otherwise combined with one or more metals selected from the group consisting of chromium, zirconium, cadmium, cobalt, nickel, beryllium, tungsten, aluminum, tungsten carbide, iron, and molybdenum. Preferably, electrodes are made of a metal alloy marketed under the fanciful trademark CMW 3 which is an R.W.M.A. Group A, Class 2 alloy identified as 2.18200 having copper and chromium as the principal elements, offered by the Assignee of this patent application. Such alloy provides good weldability for zinc plated galvanized steel and is considerably less expensive than many other materials such as dispersion-strengthened copper. CMW 3 copper alloy material comprises from about 0.6% to 1.2% chromium, the balance essentially copper.”

Among other things, Bush does not teach or suggest the use of a contact tip that has a generally cylindrical insert, a silver composition brazed onto a bore, elemental concentrations of elements in the silver composition, elemental concentrations of copper alloys used in the electrode body (225) or an insert containing tellurium for insertion into the bore.

16) U.S. Pat. No. 5,032,358—Helenius enables a resistance welding electrode of chalcogene bearing copper alloy.

Among other things, Helenius does not teach or suggest the use of a contact tip that has an insert extending beyond the contact tip, brazing a silver composition onto a bore, elemental concentrations of elements in the silver composition or the use of tungsten.

17) U.S. Pat. No. 5,914,057—Nippert, et al. enables a resistance welding electrode and process for making.

Among other things, Nippert does not teach or suggest the use of a contact tip that has an insert extending beyond the contact tip, brazing a silver composition onto a bore, elemental concentrations of elements in the silver composition or an insert containing tellurium for insertion into the bore.

18) U.S. Pat. No. 6,047,471—Nippert, et al. enables a method of making a resistance welding electrode.

Among other things, Nippert does not teach or suggest the use of a contact tip that has an insert extending beyond the contact tip, brazing a silver composition onto a bore, elemental concentrations of elements in the silver composition or an insert containing tellurium for insertion into the bore.

19) U.S. Pat. No. 6,433,300—McBennett enables an electrode interface bonding. McBennett teaches a plasma arch torch rather than a resistance welder. Column 5, in part, reads, “For example, in one particular embodiment of the present invention, the separator 32 is composed of a silver alloy material comprising silver alloyed with about 0.25 to 10 percent of an additional material selected from the group consisting of copper, aluminum, iron, lead, zinc, and alloys thereof. The additional material may be in elemental or oxide form, and thus the term “copper” as used herein is intended to refer to both the elemental form as well as the oxide form, and similarly for the terms “aluminum” and the like.”

Among other things, McBennett does not teach or suggest the use of a contact tip that has an insert extending beyond the contact tip, brazing a silver composition onto a bore, elemental concentrations of elements in the silver composition, nickel, tin or phosphorous in the silver composition or an insert containing tellurium for insertion into the bore.

20) US Pub. Patent Application No. 20050092728—Barbeau, et al. enables an resistance welding electrode and associated manufacturing method. Paragraph 68 reads, “The material making up the core 2, hereafter referred to as Bicop, is a dispersoid copper-based alloy.” And Paragraph 74 reads, “The shell 3 of the electrode 1 is made from copper-chromium or copper-chromium-zirconium alloy. This shell thus possesses mechanical, electrical and forming properties that differ significantly from those of the core.”

Among other things, Barbeau does not teach or suggest the use of a contact tip that has an insert extending beyond the contact tip, brazing a silver composition onto a bore, elemental concentrations of elements in the silver composition or any tin or phosphorous or an insert containing tellurium for insertion into the bore.

### SUMMARY OF THE INVENTION

The present contact tip is attached to a resistance welder. Among other things, the current contact tip is particularly useful when attached to the electrode of a resistance welder. Within the scope of the present invention, contact tips have inserts composed of blends of tungsten, tellurium and copper or tungsten, chromium, zirconium, silver tungsten, tellurium and copper. In practice, after the insert is inserted into the bore of the body of the contact tip, the insert abuts the silver layer brazed on to the bore.

An aspect the present invention is to provide a contact tip for an electrode of a resistance welder having an insert with a rounded tip where the rounded tip rather than the body of the contact tip bears majority of the wear.

It is another aspect of the present invention is to provide inserts for a contact tip for an electrode of a resistance welder where the insert is replaceable.

Still another aspect of the present invention is to provide inserts for a contact tip for an electrode of a resistance welder where inserts rather than the body of the contact tip are replaced.

Yet another aspect of the present invention is to provide inserts for a contact tip for an electrode of a resistance welder where inserts are primarily composed of blends of tungsten, tellurium and copper or tungsten, chromium, zirconium, silver tungsten, tellurium and copper.

Still another aspect of the present invention is to apply a layer of a composition containing silver to the bore of the contact tip that receives the insert, where the elementary concentrations of the composition containing silver are varied according to predetermined engineering parameters.

It is another aspect of the present invention to provide generally bullet shaped contact tip as well as contact tips manufactured to other dimensions.

Yet another aspect of the present invention is to provide a contact tip for an electrode of a resistance welder where the contact tip is lesser cost to the consumer than previous art resistance weld tips.

Still another aspect of the present invention is provide a contact tip for an electrode of a resistance welder that increases the quality of the weld over previous resistance weld tips.

It is another aspect of the present invention to provide a contact tip for an electrode of a resistance welder that requires less electrical power consumption that previous resistance weld tips.

Yet another aspect of the present invention is to provide an environmentally friendly contact tip where, in response to the wear and tear of use, the insert rather than the body of the contact tip can be replaced.

Still another aspect of the present invention is to provide a contact tip for an electrode of a resistance welder that decreases sticking of the contact tip to zinc-plated metal.

It is still another aspect of the present invention is to provide a contact tip for an electrode of a resistance welder where the insert of the contact tip is capable of welding more than 10,000 welds on cold rolled steel while less than 5% of the insert is worn away.

Yet another aspect of the present invention is to provide a contact tip for an electrode of a resistance welder where the insert of the contact tip is capable of welding more than 6,000 welds on electro-galvanized steel while 20% or less of the insert is worn away.

An embodiment of the present invention can be described as a resistance welder comprising an electrode and a contact tip affixed to an end of the electrode, wherein the contact tip comprises: a) a generally bullet shaped body comprising at least 99.0% w/w copper; the generally bullet shaped body further comprising: i) n outer periphery and a generally convex end; ii) a recess extending from about the generally convex end toward an open end of the generally bullet shaped body, wherein the recess is tapered and includes an outward radius that is greater than an inward radius such that the generally bullet shaped body can be attached to the electrode; iii) a generally cylindrically shaped bore distinct from and concentric with the recess and extending from the outer periphery of the generally convex end toward the recess; and iv) a solid region between the outer periphery, the bore and the recess; b) from about 0.001 micrometers to about 2 millimeters of a composition containing silver brazed onto the generally cylindrically shaped bore, wherein the composition containing silver comprises: i) from about 1% w/w silver to about 92% w/w silver; ii) from about 20% w/w copper to about 97% w/w copper; iii) up to about 43% w/w zinc; and one or more of the following: A) up to about 10% w/w nickel; B) up to about 10% w/w tin; C) up to about 10% w/w phosphorous; and c) a generally cylindrical insert comprising: i) a generally convex outward edge for engaging a work piece, the generally convex outward edge extending for more than 3.175 millimeters beyond the outer periphery of the generally convex end of the generally bullet shaped body; and ii) a combination of tungsten, tellurium and copper; the combination comprising: A) from about 10% w/w copper to about 75% w/w copper; B) from about 25% w/w tungsten to about 90% w/w tungsten; and C) from about 0.4% w/w to about 0.6% w/w tellurium; or iii) a combination of tungsten, chromium, zirconium, silver tungsten, tellurium and copper; the combination comprising: A) up to about 1% w/w chromium; B) up to about 0.4% w/w zirconium; C) up to about 0.6% w/w tellurium; D) up to about 5.0% w/w silver tungsten; E) up to about 30% w/w tungsten; and F) up to about 80% w/w copper.

Another embodiment of the present invention can be described as a replaceable contact tip connectable with an end of an electrode of a resistance welder, the contact tip comprising: a) an outer body comprising: i) ETP copper; or ii) class 1 copper; or iii) greater than 99.5% w/w copper; b) a convex contact end integral with the outer body; c) a connectable end, opposite the contact end, for fitting with the end of the electrode; d) a recess extending from proximate the convex contact end to the connectable end; e) bore distinct from the recess and extending inward from the convex contact end; f) a layer of a composition containing silver lining the bore; the layer comprising: i) from about 1% w/w silver to about 92% w/w silver; ii) from about 20% w/w copper to about 97% w/w copper; and two or more of the following: A) up to about 43% w/w zinc; B) up to about 10% w/w nickel; C) up to about 10% w/w tin; D) up to about 10% w/w phosphorous; and g) a generally cylindrical insert contacting the silver lining and extending outward for more than 3.175 millimeters beyond an outer periphery of the convex contact end; the generally cylindrical insert comprising: i) a generally convex outward edge; and ii) a combination of tungsten, tellurium and copper; or iii) a combination of tungsten, chromium, zirconium, silver tungsten, tellurium and copper.

Another embodiment of the present invention can be described as a contact tip for an end of an electrode of a resistance welder, comprising: a) an outer body comprising: i) ETP copper; or ii) class 1 copper; or iii) greater than 99.5% w/w copper; and iv) a generally rounded contact end; b) a connectable end, opposite the generally rounded contact end, for fitting with the end of the electrode; c) a recess extending from proximate the generally rounded contact end to the connectable end; d) a bore distinct from the recess and extending inward from the generally rounded contact end; e) a layer of a composition containing silver lining the bore; the composition comprising: i) from about 1% w/w silver to about 92% w/w silver; ii) from about 20% w/w copper to about 97% w/w copper; and two or more of the following: A) up to about 43% w/w zinc; B) up to about 10% w/w nickel; C) up to about 10% w/w tin; D) up to about 10% w/w phosphorous; and f) a generally cylindrical insert comprising a convex contact edge and tellurium; the generally cylindrical insert contacting the silver lining and extending outward for more than 3.175 millimeters beyond an outer periphery of the generally rounded contact end.

It is the novel and unique interaction of these simple elements which creates the methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF. THE DRAWINGS

FIG. 1 is an exploded isometric pictorial of an embodiment of a contact tip.

FIG. 2 is an isometric pictorial of an embodiment of a contact tip.

FIG. 2A is an isometric pictorial of another embodiment of a contact tip.

### DESCRIPTION OF THE PREFERRED EMBODIMENTS

Although the disclosure hereof is detailed to enable those skilled in the art to practice the invention, the embodiments published herein merely exemplify the present invention.

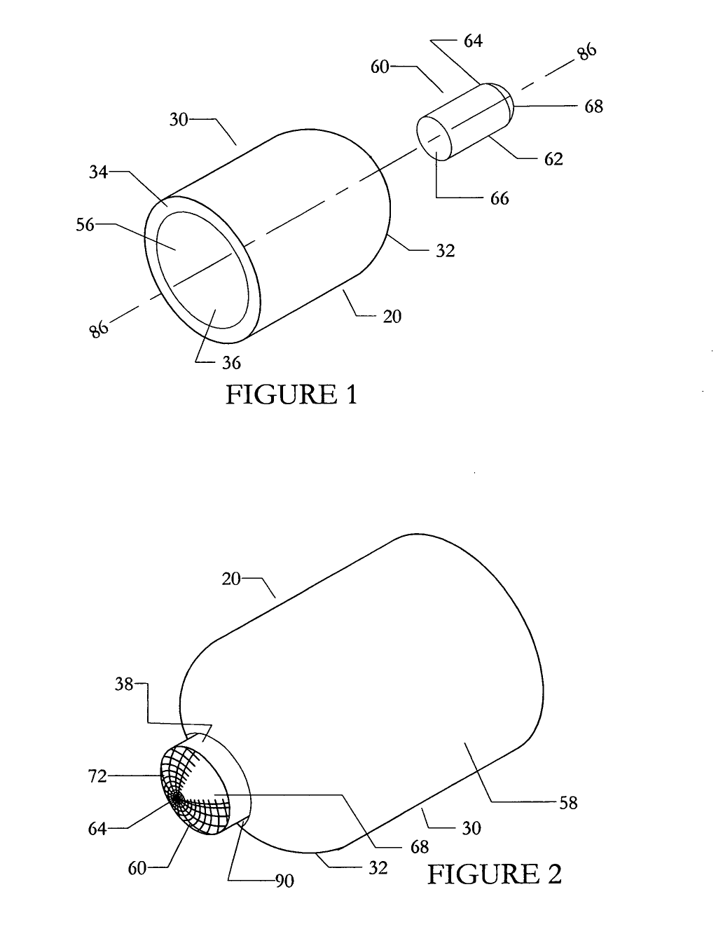

Embodiments of the current contact tip for an electrode of a resistance welder are portrayed in FIGS. 1-3. For ease of understanding, descriptions of the preferred embodiments disclosed herein may be referenced in one or more of FIGS. 1-3.

FIG. 1 is an exploded isometric pictorial an embodiment of contact tip (20) including body (30) and insert (60).

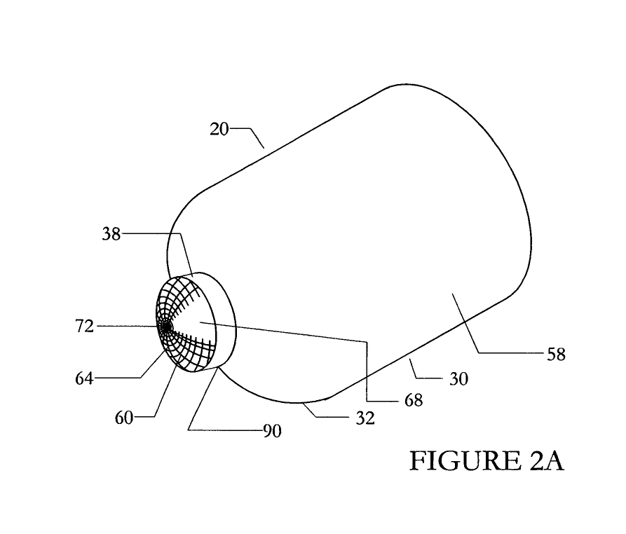

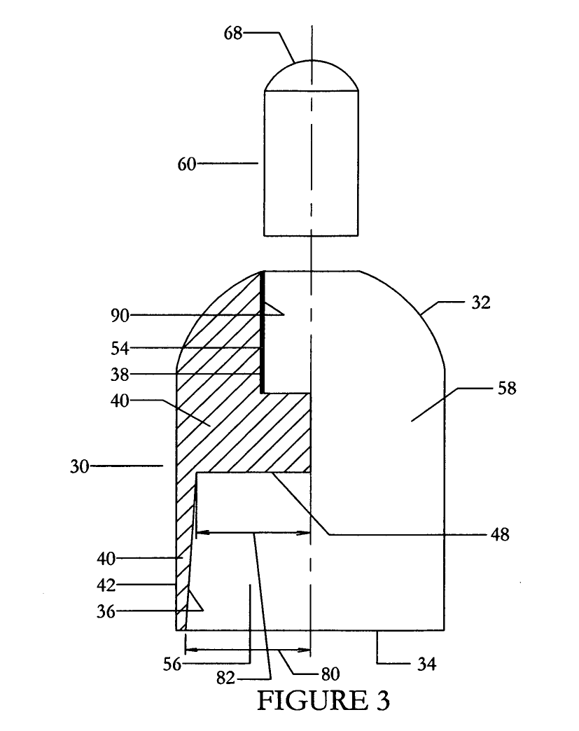

FIG. 2 is an isometric pictorial of contact tip (20) incorporating insert (60) having a first end tip (64) extending from body (30).

FIG. 2A is an isometric pictorial of contact tip (20) incorporating insert (60) having a first end tip (64) extending from body (30) where bore (38), insert (60), and layer (90) of a composition containing silver are offset from the central longitudinal axis (86-86) of body (30) of contact tip (20).

FIG. 3 is an exploded half section of contact tip (20) showing body (30), generally solid region (40) between periphery (42) and aperture (36), bore (38) and layer (90) of a composition containing silver.

Although the contact tips (20) enabled in FIGS. 1-3 show generally bullet shaped configurations, contact tips having dimensions other that bullet-like are within the scope of the present invention. In other words, the shape of the electrodes to be fitted with contact tips, within the ambit of the present invention, controls the dimensions of the contact tips.

As previously indicated, contact tip (20) includes body (30) and insert (60). Body (30) can be provided with rounded end (32), electrode connectable end (34), aperture (36) and bore (38). Aperture (36) is sized to fit about the tip of an electrode of a resistance welder. Generally cylindrically shaped insert (60) is provided with a generally cylindrical body (62), a first end tip (64) and a second end tip (66). First end tip (64) has a rounded or convex dimension (68).

With a view toward FIG. 2, contact tip (20) includes body (30), insert (60) and layer (90) of a composition containing silver. Layer (90) of a composition containing silver is brazed to bond layer (90) to bore (38). FIG. 2A shows bore (38), insert (60), and layer (90) of, a composition containing silver offset from the central longitudinal axis (86-86) of body (30) of contact tip (20).

As can be seen in FIG. 3, body (30) has a generally solid region (40) between periphery (42) and aperture (36) and bore (38). Generally solid region (40) surrounding bore (38) (work piece contact end) is of greater mass than generally solid region (40) surrounding aperture (36) (electrode connectable end). The combination of aperture (36) and generally solid region (40) create recess (56) that can be fitted for an electrode of a resistance welder. As shown, bore (38) does not extend through generally solid region (40) to recess (56), but in select embodiments, bore (38) can extend through generally solid region (40) to recess (56). In select preferred embodiments, outward radius (80) of recess (56) is of greater length than inward radius (82) of recess (56). From outward side of aperture (36) to inward side (48) of recess (56), recess (56) is tapered away from outer periphery (58) of body (30). Affixed to exposed surface (54) of bore (38) is layer (90) of a composition containing silver. Through experimentation, Applicants have determined that preferred thicknesses of layer (90) of contact tip (20) are from about 0.001 micrometers to about 2 millimeters.

Table 1 shows the wear of the insert welding cold roll steel, where the insert includes blends of copper and tungsten as disclosed in this application.

TABLE 1

| | | Weld time | Nugget | Insert Wear |
|---|---|---|---|---|
| Weld # | KVA | (cycles) | (mm) | (%) |
| 1 | 7 | 6 | 4.02 | 0 |
| 500 | 7 | 6 | 4.18 | <5 |
| 1000 | 7 | 6 | 4.01 | <5 |
| 1500 | 7 | 6 | 4.31 | <5 |
| 2000 | 7 | 6 | 4.2 | <5 |
| 2500 | 7 | 6 | 4.01 | <5 |
| 3000 | 7 | 6 | 3.92 | <5 |
| 3500 | 7 | 6 | 3.81 | <5 |
| 4000 | 7 | 6 | 3.84 | <5 |
| 4500 | 7 | 6 | 3.95 | <5 |
| 5000 | 7 | 6 | 4.19 | <5 |
| 6000 | 7 | 6 | 4.12 | <5 |
| 7000 | 7 | 6 | 4.26 | <5 |
| 8000 | 7 | 6 | 3.95 | <5 |
| 9000 | 7 | 6 | 4.12 | <5 |
| 10000 | 7 | 6 | 4 | <5 |
| 20000 | 7 | 6 | 3.65 | <10 |
| 30000 | 7 | 6 | 4.01 | <10 |

Table 2 shows the wear of the insert welding electro-galvanized steel, where the insert includes blends of copper and tungsten as disclosed in this application.

TABLE 2

| | | Weld time | Nugget | Insert Wear |
|---|---|---|---|---|
| Weld # | KVA | (cycles) | (mm) | (%) |
| 1 | 8 | 6 | 4.06 | 0 |
| 500 | 8.5 | 6 | 4.06 | <5 |
| 1000 | 9 | 6 | 5.03 | 5 |
| 1500 | 9.5 | 6 | 3.31 | <10 |
| 2000 | 9.5 | 6 | 4.45 | <10 |
| 2500 | 10 | 6 | 4.01 | 10 |
| 3000 | 10 | 6 | 4.06 | <15 |
| 3500 | 10 | 6 | 3.68 | <15 |
| 4000 | 10 | 6 | 3.31 | 15 |
| 4500 | 10.5 | 6 | 3.68 | 15 |
| 5000 | 10.5 | 6 | 3.31 | <20 |
| 6000 | 10.5 | 6 | 3.27 | 20 |
| 7000 | 11 | 6 | 3.41 | <25 |
| 8000 | 11.5 | 6 | 3.31 | 25 |

Within the scope of embodiments of the present invention, Applicants' experiments have revealed that compositions of the bodies are ETP copper, class 1 copper and/or greater than 99.5% w/w copper. In other words, contact tip bodies can include at least 99.0% w/w copper.

Within the scope of embodiments of the current invention, through experimentation, Applicants have concluded that compositions of select preferred embodiments of inserts can include blends of:

a) from about 10% w/w copper to about 75% w/w copper;

b) from about 25% w/w tungsten to about 90% w/w tungsten; and

c) from about 0.4% w/w to about 0.6% w/w tellurium.

Within the scope of embodiments of the current invention, through experimentation, Applicants have concluded that compositions of select preferred embodiments of inserts can include blends of:

a) up to about 1% w/w chromium;

b) up to about 0.4% w/w zirconium;

c) up to about 0.6% w/w tellurium;

d) up to about 5.0% w/w silver tungsten;

e) up to about 30% w/w tungsten; and

f) up to about 80% w/w copper.

Applicants' experiments have unexpectedly revealed that contact tips containing blends of copper, chromium, zirconium and tellurium can make more than 19,000 welds on electro-galvanized steel before the contact tip is no longer functional.

Within the scope of embodiments of the current invention, through laboratory testing, Applicants have concluded that compositions containing silver used to practice the present invention can include blends of:

a) from about 1% w/w silver to about 92% w/w silver;

b) from about 20% w/w copper to about 97% w/w copper;

c) from about 0% w/w zinc to about 43% w/w zinc;

d) from about 0% w/w nickel to about 10% w/w nickel;

e) from about 0% w/w tin to about 10% w/w tin; and

f) from about 0% w/w phosphorus to about 10 w/w phosphorous.

Applicants have discovered that embodiments of the current contact tips containing compositions including silver are advantageous over previous weld rips for resistance welders. By way of illustration the disclosed combinations of silver, copper and tungsten are better electrical conductors than the previous weld tips. Further, the brazing of the composition containing silver, the contact tip body and the insert improves affixation of the insert to the contact tip body. The brazing process of the composition containing silver, the contact tip body and the insert creates a contact tip that causes a reduction of electrical power consumption required by the electrode in generating the weld. Further, it has been discovered that the combination of the contact tip's body and insert is capable of reducing electrical power consumption when the insert's contact with the article to be welded is perpendicular to the article, such as steel, to be welded. Reduced electrical power consumptions of 20-30% as compared currently existing contact tips are within the scope of the present invention. It has unexpectedly been discovered that the combination of the compositions of the inserts and the unused extension of the insert to about 6.35 millimeters beyond the outer periphery of the generally convex end (32) of body (30) as compared with currently available inserts that do not extend more than 3.175 millimeters beyond the outer periphery of the body provides for longer wear of the contact tip as well as reduced power consumption by the contact tip.

Having disclosed the invention as required by Title 35 of the United States Code, Applicants now pray respectfully that Letters Patent be granted for their invention in accordance with the scope of the claims appended hereto.

What is claimed is:

1) A resistance welder comprising an electrode and a contact tip affixed to an end of said electrode, wherein said contact tip comprises:
a) a generally bullet shaped body comprising at least 99.0% w/w copper; said generally bullet shaped body further comprising:
i) an outer periphery and a generally convex end;
ii) a recess extending from about said generally convex end toward an open end of said generally bullet shaped body, wherein said recess is tapered and includes an outward radius that is greater than an inward radius such that said generally bullet shaped body can be attached to said electrode;
iii) a generally cylindrically shaped bore distinct from and concentric with said recess and extending from said outer periphery of said generally convex end toward said recess; and
iv) a solid region between said outer periphery, said bore and said recess;
b) from about 0.001 micrometers to about 2 millimeters of a composition containing silver brazed onto said generally cylindrically shaped bore, wherein said composition containing silver comprises:
i) from about 1% w/w silver to about 92% w/w silver;
ii) from about 20% w/w copper to about 97% w/w copper;
iii) up to about 43% w/w zinc; and one or more of the following:
A) up to about 10% w/w nickel;
B) up to about 10% w/w tin;
C) up to about 10% w/w phosphorous; and
c) a generally cylindrical insert comprising:
i) a generally convex outward edge for engaging a work piece, said generally convex outward edge extending for more than 3.175 millimeters beyond said outer periphery of said generally convex end of said generally bullet shaped body; and
ii) a combination of tungsten, tellurium and copper; said combination comprising:
A) from about 10% w/w copper to about 75% w/w copper;
B) from about 25% w/w tungsten to about 90% w/w tungsten; and
C) from about 0.4% w/w to about 0.6% w/w tellurium; or
iii) a combination of tungsten, chromium, zirconium, silver tungsten, tellurium and copper; said combination comprising:
A) up to about 1% w/w chromium;
B) up to about 0.4% w/w zirconium;
C) up to about 0.6% w/w tellurium;
D) up to about 5.0% w/w silver tungsten;
E) up to about 30% w/w tungsten; and
F) up to about 80% w/w copper.

2) The invention of claim 1, wherein said insert extends beyond said outer periphery of said generally convex end of said generally bullet shaped body from about 3.175 millimeters to about 6.35 millimeters.

3) The invention of claim 2, wherein prior to a first use, said insert extends beyond said outer periphery of said generally convex end of said generally bullet shaped body about 6.35 millimeters.

4) A replaceable contact tip connectable with an end of an electrode of a resistance welder, said contact tip comprising:
a) an outer body comprising:
i) ETP copper; or
ii) class 1 copper; or
iii) greater than 99.5% w/w copper;
b) a convex contact end integral with said outer body;
c) a connectable end, opposite said contact end, for fitting with said end of said electrode;
e) a recess extending from proximate said convex contact end to said connectable end;
f) a bore distinct from said recess and extending inward from said convex contact end;
g) a layer of a composition containing silver lining said bore; said layer comprising:
i) from about 1% w/w silver to about 92% w/w silver;
ii) from about 20% w/w copper to about 97% w/w copper; and two or more of the following:
A) up to about 43% w/w zinc;
B) up to about 10% w/w nickel;
C) up to about 10% w/w tin;
D) up to about 10% w/w phosphorous; and
f) a generally cylindrical insert contacting said silver lining and extending outward for more than 3.175 millimeters beyond an outer periphery of said convex contact end; said generally cylindrical insert comprising:
i) a generally convex outward edge; and
ii) a combination of tungsten, tellurium and copper; or
iii) a combination of tungsten, chromium, zirconium, silver tungsten, tellurium and copper.

5). The invention of claim 4, wherein said generally cylindrical insert comprises:
a) from about 10% w/w copper to about 75% w/w copper; from about 25% w/w tungsten to about 90% w/w tungsten; and from about 0.4% w/w to about 0.6% w/w tellurium; or
b) up to about 1% w/w chromium; up to about 0.4% w/w zirconium; up to about 0.6% w/w tellurium; up to about 5.0% w/w silver tungsten; up to about 30% w/w tungsten; and up to about 80% w/w copper.

6) The invention of claim 5, wherein said recess is tapered and includes an outward radius that is greater than an inward radius such that said body can be attached to said electrode.

7) The invention of claim 6, wherein said generally cylindrical insert extends beyond said outer periphery of said generally convex end of said generally bullet shaped body from about 3.175 millimeters to about 6.35 millimeters.

8) The invention of claim 7, wherein said layer is from about 0.001 micrometers to about 2 millimeters.

9) The invention of claim 8, wherein said bore is concentric with said recess.

10) The invention of claim 9, wherein prior to a first use, said generally convex edge of said insert extends about 6.35 millimeters beyond said outer periphery of said generally convex end of said body.

11) A contact tip for an end of an electrode of a resistance welder, comprising:
a) an outer body comprising:
i) ETP copper; or
ii) class 1 copper; or
iii) greater than 99.5% w/w copper; and
iv) a generally rounded contact end;
b) a connectable end, opposite said generally rounded contact end, for fitting with said end of said electrode;
c) a recess extending from proximate said generally rounded contact end to said connectable end;
d) a bore distinct from said recess and extending inward from said generally rounded contact end;
e) a layer of a composition containing silver lining said bore; said composition comprising:
i) from about 1% w/w silver to about 92% w/w silver;
ii) from about 20% w/w copper to about 97% w/w copper; and two or more of the following:
A) up to about 43% w/w zinc;
B) up to about 10% w/w nickel;
C) up to about 10% w/w tin;
D) up to about 10% w/w phosphorous; and
f) a generally cylindrical insert comprising a convex contact edge and tellurium; said generally cylindrical insert contacting said silver lining and extending outward for more than 3.175 millimeters beyond an outer periphery of said generally rounded contact end.

12) The invention of claim 11, wherein said generally cylindrical insert's concentration of tellurium ranges of from about 0.4% w/w to about 0.6% w/w.

13) The invention of claim 12, wherein said recess is tapered and includes an outward radius that is greater than an inward radius such that said body can be attached to said electrode.

14) The invention of claim 13, wherein said generally cylindrical insert further comprises:
a) from about 10% w/w copper to about 75% w/w copper and from about 25% w/w tungsten to about 90% w/w tungsten; or
b) up to about 1% w/w chromium; up to about 0.4% w/w zirconium; up to about 5.0% w/w silver tungsten; up to about 30% w/w tungsten; and up to about 80% w/w copper.

15) The invention of claim 14, wherein said generally cylindrical insert extends beyond said outer periphery of said outer periphery of said generally rounded contact end from about 3.175 millimeters to about 6.35 millimeters.

16) The invention of claim 15, wherein said bore is concentric with said recess.

17) The invention of claim 16, wherein said layer is from about 0.001 micrometers to about 2 millimeters of a composition containing silver.

18) The invention of claim 17, wherein prior to a first use, said generally convex edge of said insert extends about 6.35 millimeters beyond said outer periphery of said generally rounded contact end.
